(19) United States
(12) Patent Application Publication
(10) Pub. No.: US 2016/0151235 A1
(43) Pub. Date: Jun. 2, 2016

(54) MASSAGE DEVICE

(71) Applicants: HSIEN-WEN YU, NEW TAIPEI CITY (TW); CHENG-HUAN YANG, NEW TAIPEI CITY (TW)

(72) Inventors: HSIEN-WEN YU, NEW Taipei City (TW); CHENG-HUAN YANG, NEW TAIPEI CITY (TW); PIN-SI LIN, New Taipei City (TW)

(21) Appl. No.: 14/952,843

(22) Filed: Nov. 25, 2015

(30) Foreign Application Priority Data
Dec. 2, 2014 (TW) 103141769

(51) Int. Cl. A61H 15/00

(52) U.S. Cl. CPC A61H 15/0092

(57) ABSTRACT

A massage device includes a shaft and a detachable massage member. The shaft has a first end provided with a connector for releasably connecting the shaft to a swivel joint. The detachable massage member is detachably connected at a proximal end to an opposite second end of the shaft. With the above arrangements, the massage device can be conveniently operated directly by a user to achieve the effect of deep massage of a variety of muscles.

### CROSS-REFERENCE TO RELATED APPLICATION

This non-provisional application claims priority under 35 U.S.C. §119(a) on Patent Application No(s).103141769 filed in Taiwan, R.O.C. on Dec. 2, 2014, the entire contents of which are hereby incorporated by reference.

### FIELD OF THE INVENTION

The present invention relates to a massage device, and more particularly to a massage device that can be conveniently operated directly by a user to achieve the effect of deep massage of a variety of muscles.

### BACKGROUND OF THE INVENTION

People often take exercise as a training before taking part in a sport, game or physical activity, or as a means to keep body in a health condition. However, during the process of taking exercise, people's deep muscles might get injured due to strenuous exercise or incorrect postures. For the deep muscles to quickly recover from the injured condition, people usually need to go to hospital for therapy or rehabilitation. However, most people returned from hospital to home do not have adequate medical appliances for continuous deep muscle massage. Therefore, it is desirable to develop a massage device that can be conveniently operated directly by a user at home to achieve the effect of deep massage of a variety of muscles.

### SUMMARY OF THE INVENTION

A primary object of the present invention is to provide a massage device that can be conveniently operated directly by a user to achieve the effect of deep massage of a variety of muscles.

To achieve the above and other objects, the massage device provided according to the present invention includes a shaft having a first end provided with a connector for releasably connecting the shaft to a swivel joint; and a detachable massage member detachably connected at a proximal end to a second end of the shaft opposite to the first end.

According to the present invention, the shaft for the massage device is a lockable telescopic shaft.

According to the massage device of the present invention, the shaft can have a handle grip, which is a pivotal handle grip pivotally turnable to a folded position.

According to the massage device of the present invention, the connector for releasably connecting the shaft to a swivel joint can be male fastening means or female fastening means; or be a magnetic attraction member.

According to the massage device of the present invention, when the connector is a magnetic attraction member, the magnetic attraction member includes a cap and a magnetic member. The cap is disposed in the first end of the shaft and is formed with a connection recess for engaging with the swivel joint. The magnetic member is disposed in the cap to locate in the vicinity of the connection recess.

According to the massage device of the present invention, the detachable massage member can be a J-shaped rod or a straight rod.

According to the massage device of the present invention, the detachable massage member is covered with a soft material layer.

According to the massage device of the present invention, the detachable massage member is provided at the proximal end with male threads and the shaft is correspondingly provided at the second end with female threads for releasably meshing with the male threads on the detachable massage member; or alternatively, the detachable massage member is provided at the proximal end with female threads and the shaft is correspondingly provided at the second end with male threads for releasably meshing with the female threads on the detachable massage member.

According to the massage device of the present invention, there is further included a supporting member formed of a swivel joint and a base. The swivel joint has an end releasably connected to the connector provided at the first end of the shaft and another end connected to the base.

According to the massage device of the present invention, there is further included a support element disposed on the base to provide a support to a bottom of the swivel joint.

According to the massage device of the present invention, when the connector is a magnetic attraction member, the massage device further includes a supporting member formed of a swivel joint and a base. The swivel joint is magnetically attractable and has an end magnetically attracted to the magnetic attraction member and another end connected to the base.

According to the massage device of the present invention, there is further included a supporting member formed of a swivel joint and a base. The swivel joint is magnetically attractable and includes an engaging rod adapted for fitting in the connection recess of the shaft and magnetically attracted to the magnetic member disposed in the shaft. And, the swivel joint has an end connected to the base.

According to the massage device of the present invention, the swivel joint further includes a connection ball, a semicircular ball seat and a ring-shaped cover. The engaging rod has an end connected to the connection ball; the connection ball is movably received in the semicircular ball seat; and the ring-shaped cover is disposed on a top of the semicircular ball seat and has a radially inward protruded top rim for stopping the connection ball from moving out of the semicircular ball seat via the ring-shaped cover.

According to the massage device of the present invention, the base has a receiving space and an extended receiving space defined thereon, and the semicircular ball seat and the ring-shaped cover respectively have a notch formed on one side thereof. The semicircular ball seat and the ring-shaped cover are disposed in the receiving space; and the notches allow the engaging rod to move between the extended receiving space and an outer side of the receiving space.

According to the massage device of the present invention, the supporting member further includes a flexible annular cover plate having a slit provided thereon. The flexible annular cover plate is disposed on a top of the base to locate outside the receiving space and the extended receiving space; and the slit allows the engaging rod to move between the extended receiving space and an outer side of the receiving space.

According to the massage device of the present invention, the base is polygonal in shape to have a plurality of side surfaces and a bottom surface, and an anti-slip layer is provided on each of the side surfaces and the bottom surface.

According to the massage device of the present invention, a massage ball may be further provided and disposed on the base. A concave recess can be formed on the base for holding the massage ball therein.

With the above arrangements, the massage device of the present invention can be conveniently operated directly by the user to achieve the effect of deep massage of a variety of muscles.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a massage device according to a first embodiment of the present invention;

FIG. 2 is an assembled view of FIG. 1;

FIG. 3 shows a shaft for a massage device according to a second embodiment of the present invention;

FIG. 4 is an exploded perspective view showing a magnetic attraction member for the massage device according to the second embodiment of the present invention;

FIG. 5 is an assembled sectional view of FIG. 4;

FIG. 6 is a perspective view showing a straight rod forming a detachable massage member for the massage device according to the second embodiment of the present invention;

FIG. 7 is a perspective view showing a J-shaped rod forming a detachable massage member for the massage device according to the second embodiment of the present invention;

FIG. 8 is an assembled perspective view of the massage device according to the second embodiment of the present invention;

FIG. 9 is another exploded perspective view of the massage device according to the first embodiment of the present invention;

FIG. 10 is an assembled view of FIG. 9;

FIG. 11 is an exploded perspective view of a supporting member for the massage device according to the second embodiment of the present invention, viewed from a top side thereof;

FIG. 12 is another exploded perspective view of the supporting member of FIG. 11, viewed from a bottom side thereof;

FIG. 13 is an assembled view of FIG. 11;

FIG. 14 is a top view showing an engaging rod on a swivel joint, which is included in the supporting member of the massage device according to the second embodiment of the present invention, is received in an extended receiving space formed on a base of the supporting member of FIG. 13;

FIG. 15 is an assembled sectional side view of FIG. 14;

FIG. 16 is an exploded perspective view showing the shaft and the supporting member for the massage device according to the second embodiment of the present invention before they are connected to each other;

FIG. 17 is an assembled sectional side view showing the shaft and the supporting member for the massage device according to the second embodiment of the present invention after they are connected to each other;

FIG. 18 is another assembled perspective view of the massage device according to the second embodiment of the present invention;

FIG. 19 shows a first example of using the massage device of the present invention;

FIG. 20 shows a second example of using the massage device of the present invention;

FIG. 21 shows a third example of using the massage device of the present invention; and

FIG. 22 shows a fourth example of using the massage device of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

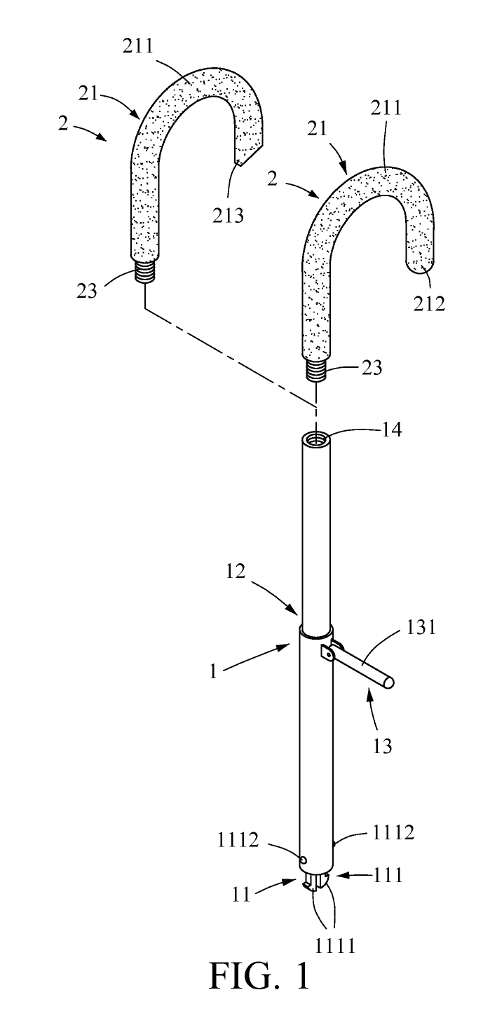

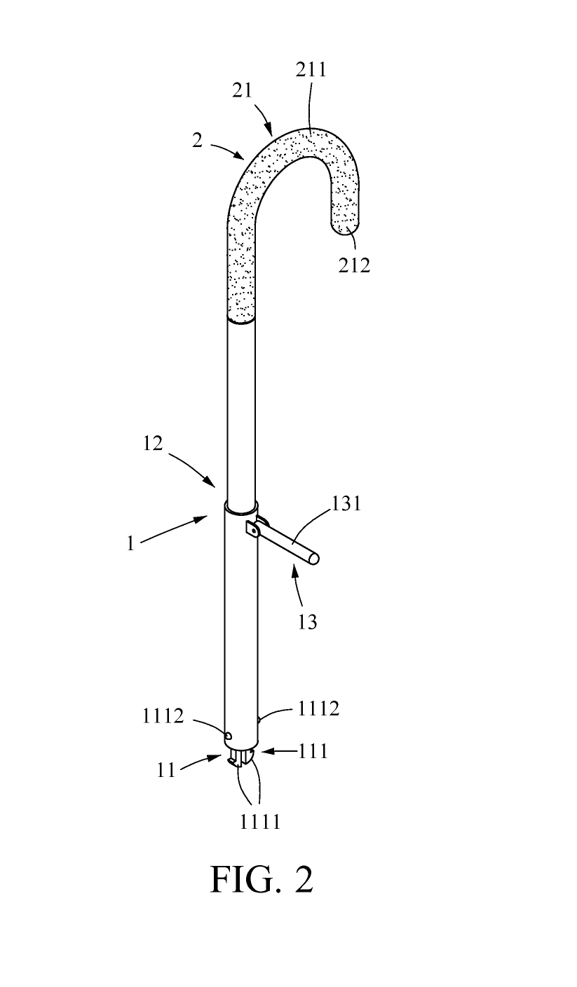

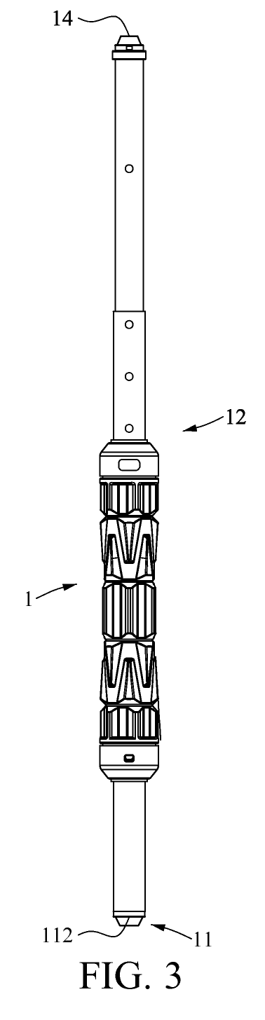

Please refer to FIGS. 1 and 2, which show a massage device according to a first embodiment of the present invention, and to FIGS. 3 through 8, which show a massage device according to a second embodiment of the present invention. As shown, the massage device in the first and the second embodiment of the present invention respectively include a shaft 1 and a detachable massage member 2. A first end of the shaft 1 is provided with a connector 11 for releasably connecting the shaft 1 to a swivel joint that is mounted on another structural body, so that the massage device can be operated to provide additional massage functions. The shaft 1 has an opposite second end, to which a proximal end of the detachable massage member 2 is detachably connected. With these arrangements, differently designed detachable massage members 2 can be selectively connected to the shaft 1 according to a user's actual need, so as to achieve the best possible massage effect.

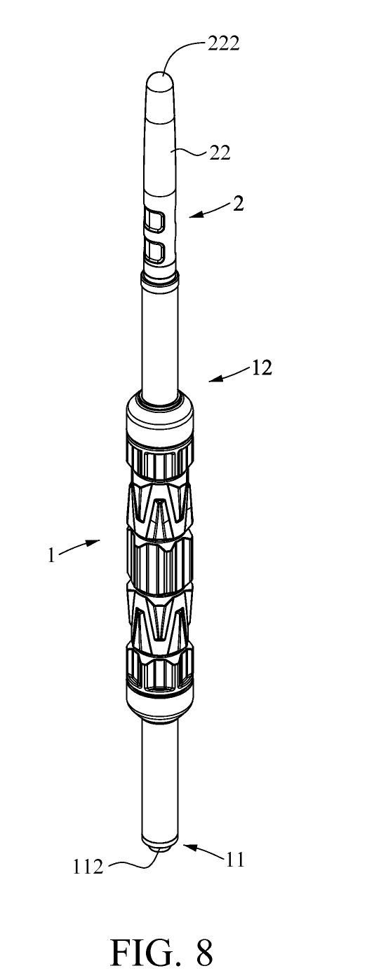

Please refer to FIGS. 1, 2, 3 and 8. In the massage device according to the first and the second embodiment, the shaft 1 can be a lockable telescopic shaft 12 formed of, for example, two sleeves that are connected together via threaded ends or corresponding locking buttons and retaining holes to enable adjustment of an overall length of the telescopic shaft 12. As shown in FIGS. 1 and 2, when the lockable telescopic shaft 12 is in a locked state, the user may apply a force against the telescopic shaft 12 to loosen the two sleeves by turning them relative to one another; and then, adjust the two sleeves in their relative position to give the telescopic shaft 12 a desired overall length; and finally, reversely turn the two sleeves relative to one another again until they are firmly locked together. Or, as shown in FIGS. 3 and 8, when the lockable telescopic shaft 12 is in a locked state, the user may loosen the two sleeves from one another by pushing two locking buttons provided on one of the sleeves for them to separate from two retaining holes correspondingly provided on the other sleeve; and then, adjust the two sleeves in their relative position to give the telescopic shaft 12 a desired overall length; and finally, set the telescopic shaft 12 to the locked state again by engaging the locking buttons with the retaining holes again. In this manner, the shaft 1 can be adjusted in length according to the user's actual need, and the massage device is more convenient for use.

Referring to FIGS. 1 and 2 again. In the massage device according to the first embodiment, the shaft 1 may further include a handle grip 13, which can be disposed at a position between the first and second ends of the shaft 1 or be provided on one of the sleeves of the lockable telescopic shaft 12. When using the massage device, the user may hold the shaft 1 with one hand and hold the handle grip 13 with the other hand, so that the massage device is more convenient for use. Or, in the case of the massage device in the second embodiment as shown in FIGS. 3 and 8, the user may, according to actual need, directly hold the shaft 1 to operate the massage device in a convenient manner.

As shown in FIGS. 1 and 2, in the massage device according to the first embodiment, the handle grip 13 can be a pivotal handle grip 131, which can be radially outwardly turned relative to the shaft 1 and secured to a position perpendicular to the shaft 1 for use. When the pivotal handle grip 131 is not in use, it can be turned toward the shaft 1 and secured to a position in parallel with the shaft 1. With these arrangements, the handle grip 13 not in use can be pivotally turned and secured to a folded position, enabling convenient storage of the massage device.

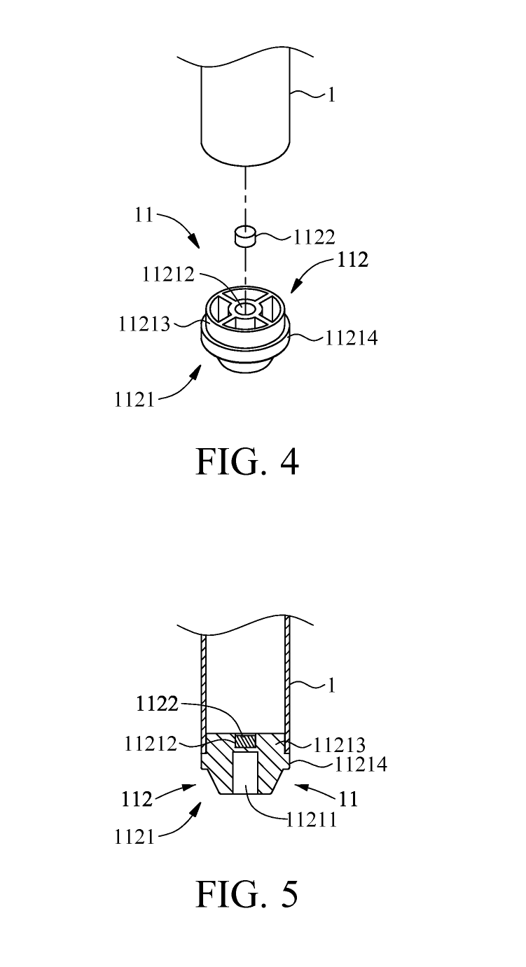

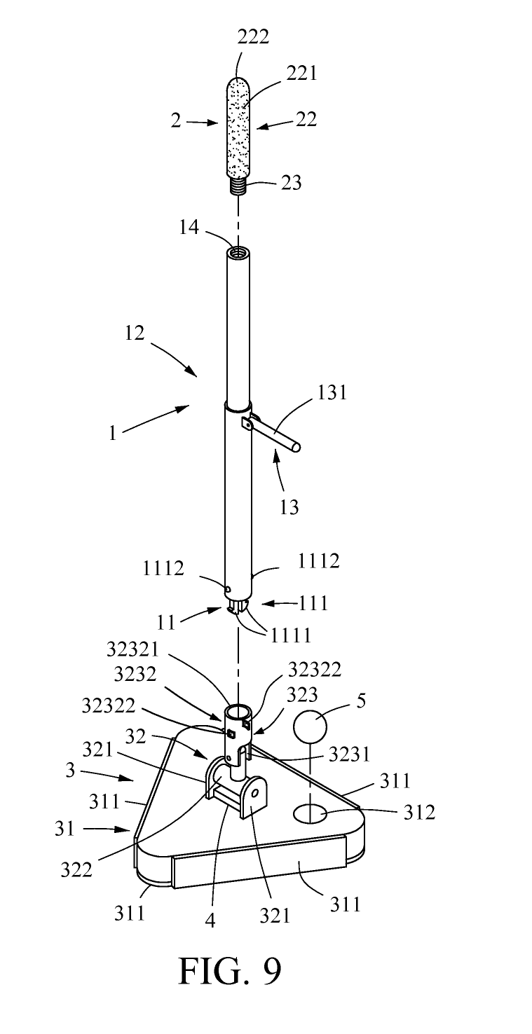

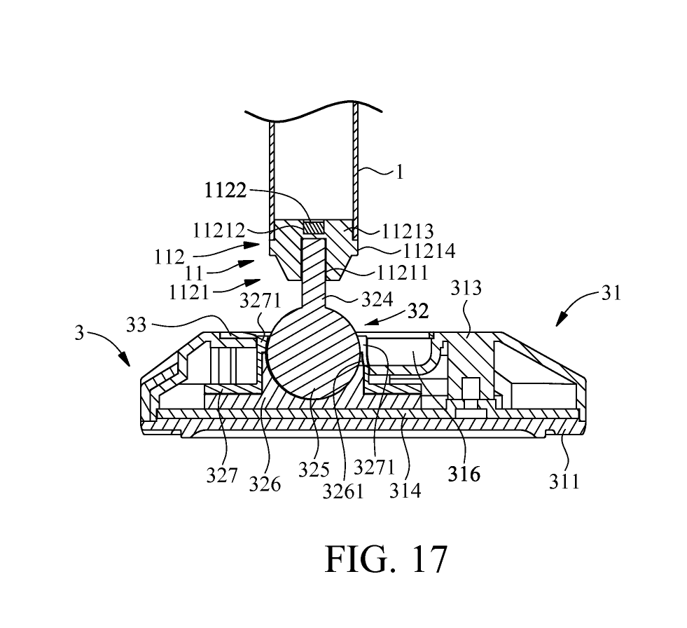

Please refer to FIGS. 1, 2 and 9 at the same time. In the massage device according to the first embodiment, the connector 11 on the shaft 1 can be male fastening means 111 (see FIG. 1) or female fastening means 3232 (see FIG. 9) adapted for detachably engaging with corresponding female fastening means 3232 or corresponding male fastening means 111 provided on a swivel joint 32. The male fastening means 111 includes two spaced spring legs 1111 axially projected from the first end of the shaft 1 and two push keys 1112 provided on the shaft 1. When the two push keys 1112 are radially inward pushed, the two spaced spring legs 1111 are brought to move toward each other. When the two push keys 1112 are released, the spring legs 1111 will be elastically restored to the originally spaced position. The female fastening means 3232 internally defines a retaining recess 32321 for receiving the spring legs 1111 therein, and has two retaining slots 32322 formed on an inner wall surface of the retaining recess 32321 for engaging with the spring legs 1111. More specifically, when the push keys 1112 are pushed, the spring legs 1111 are brought to disengage from the retaining slots 32322, allowing the shaft 1 to separate from the swivel joint 32. In another operable embodiment, the connector 11 can be otherwise male threads externally formed on around the first end of the shaft 1 or female threads internally formed in around the first end of the shaft 1 for releasably screwing to female threads or male threads correspondingly provided on the swivel joint 32. Please refer to FIGS. 4, 5 and 17 at the same time. In the massage device according to the second embodiment of the present invention, the connector 11 on the shaft 1 can be a magnetic attraction member 112 for releasably magnetically attracting a magnetically attractable end of the swivel joint 32. To release the connector 11 from the swivel joint 32, simply apply a force large enough to overcome the force of attraction between the magnetic attraction member 112 and the swivel joint 32. With these arrangements, the shaft 1 can be conveniently connected to and disconnected from other structures that have a swivel joint provided thereon, enabling the massage device of the present invention to expand its massage functions.

As can be seen in FIGS. 4 and 5, in the massage device according to the second embodiment of the present invention, the magnetic attraction member 112 includes a cap 1121 and a magnetic member 1122. The cap 1121 has an outer side formed with a connection recess 11211 for engaging with a swivel joint, and an inner side formed into an insertion stub 11213, which internally defines a receiving space 11212. The cap 1121 further includes a stop flange 11214 located between the outer and the inner side of the cap 1121. The magnetic member 1122 can be a magnet disposed in the receiving space 11212 to locate in the vicinity of the connection recess 11211. The shaft 1 is a hollow shaft. The insertion stub 11213 of the cap 1121 is adapted for inserting into the first end of the shaft 1 with the stop flange 11214 of the cap 1121 abutted on an end surface of the first end of the shaft 1. With these arrangements, the magnetic attraction member 112 can be easily connected to the shaft 1 and a swivel joint.

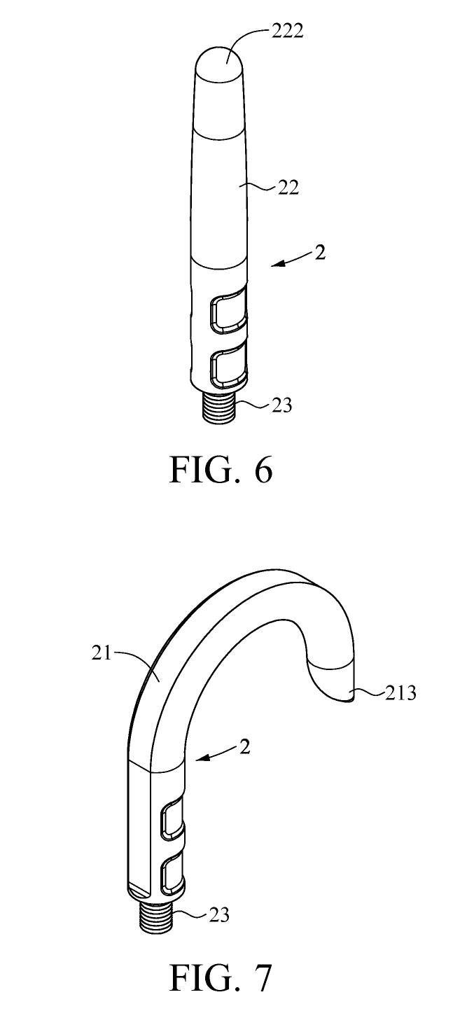

Referring to FIGS. 1 and 2. In the massage device according to the first embodiment, the detachable massage member 2 can be a J-shaped rod 21, which has a distal end formed into a spherical surface 212 for the purpose of creating a comfortable massage effect. In another operable embodiment, the J-shaped rod 21 may have a distal end formed into a wedge-shaped surface 213 for creating a compressive massage effect. Alternatively, as shown in FIG. 9, the detachable massage member 2 for the massage device of the first embodiment can be otherwise a straight rod 22, which also has a distal end formed into a spherical surface 222 for creating a comfortable massage effect. Further, as shown in FIGS. 6 and 7, in the massage device according to the second embodiment of the present invention, the detachable massage member 2 can also be a straight rod 22 having a distal end formed into a spherical surface 222 for creating a comfortable massage effect, or a J-shaped rod 21 having a distal end formed into a wedge-shaped surface 213 for creating a compressive massage effect. With these arrangements, differently designed detachable massage members 2 can be selectively connected to the shaft 1 for the massage device to create different massage effects. Further, the particularly shaped distal end of the detachable massage member 2 also enables the massage device of the present invention to create deep muscle massage effect.

Please refer to FIGS. 1 and 9. In the massage device according to the first embodiment, the detachable massage member 2 is covered with a soft material layer 211, 221. The soft material layer 211, 221 may be provided on the detachable massage member 2 at specific positions, such as the distal end or other areas of the detachable massage member 2. When the distal end of the detachable massage member 2 is pressed against a user's skin, the soft material layer 211, 221 not only functions to protect the user's skin against undesirable injury, but also ensures enhanced comfortable massage.

Referring to FIGS. 1, 3 and 6. In the massage device of the first and the second embodiment, the detachable massage member 2 can be provided at the proximal end with male threads 23 or female threads, while the shaft 1 can be correspondingly provided at the second end with female threads 14 or male threads. By releasably meshing the male threads 23 provided on the detachable massage member 2 with the female threads 14 provided on the shaft 1, or releasably meshing with the female threads provided on the detachable massage member 2 with the male threads provided on the shaft 1, the detachable massage member 2 can be conveniently connected and locked to the shaft 1 or be loosened and separated from the shaft 1.

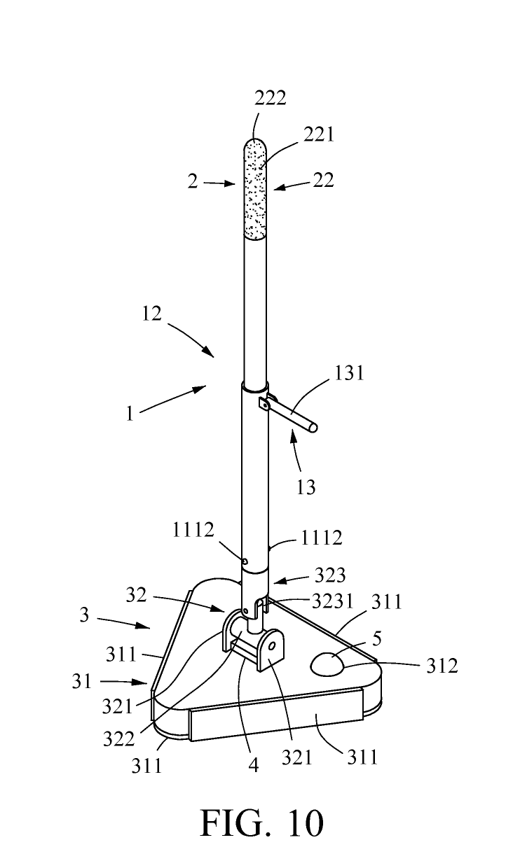

Please refer to FIGS. 9 and 10. The massage device according to the first embodiment may further include a supporting member 3, which is formed of a swivel joint 32 and a base 31. The swivel joint 32 includes two spaced lugs 321 mounted on a top of the base 31, a T-shaped rod 322, and a fork-shaped element 323 having a U-shaped cut 3231 defined at a lower part thereof. The T-shaped rod 322 includes a transverse section pivotally connected to between the two lugs 321, and a longitudinal section having a free end extended into and pivotally connected to the U-shaped cut 3231 of the fork-shaped element 323. The transverse and the longitudinal section of the T-shaped rod 322 are rotatable relative to each other. The female fastening means 3232 or the male fastening means 111 provided on the swivel joint 32 as mentioned above are actually located on the fork-shaped element 323 for detachably engaging with the male fastening means 111 or the female fastening means 3232 forming the connector 11 at the first end of the shaft 1. According to another operable embodiment, the fork-shaped element 323 of the swivel joint 32 may be otherwise provided with female threads or male threads, and the connector 11 at the first end of the shaft 1 may be otherwise in the form of male threads or female threads, so that the fork-shaped element 323 can be releasably screwed to the connector 11. In a further operable embodiment, the fork-shaped element 323 can be provided on an outer surface with an annular flange (not shown) for removably fitting in the connector 11, which is in the form of an annular groove (not shown) provided in around the first end of the shaft 1 in this case. Or, in a still further operable embodiment, the fork-shaped element 323 is internally provided with an annular groove (not shown) for removably engaging with the connector 11, which is in the form of an annular flange (not shown) provided on around the first end of the shaft 1 in this case. With the detachable massage member 2 and the shaft 1 being connected to the supporting member 3 in the above-described manners, the massage device of the present invention can provide expanded massage functions.

As can be seen in FIGS. 9 and 10, the massage device according to the first embodiment of the present invention may further include a support element 4 disposed on the base 31 to provide a support to the transverse section of the T-shaped rod 322 of the swivel joint 32. With the support element 4, the swivel joint 32 is protected against damage when the detachable massage member 2 and the shaft 1 are excessively pushed downward by a user.

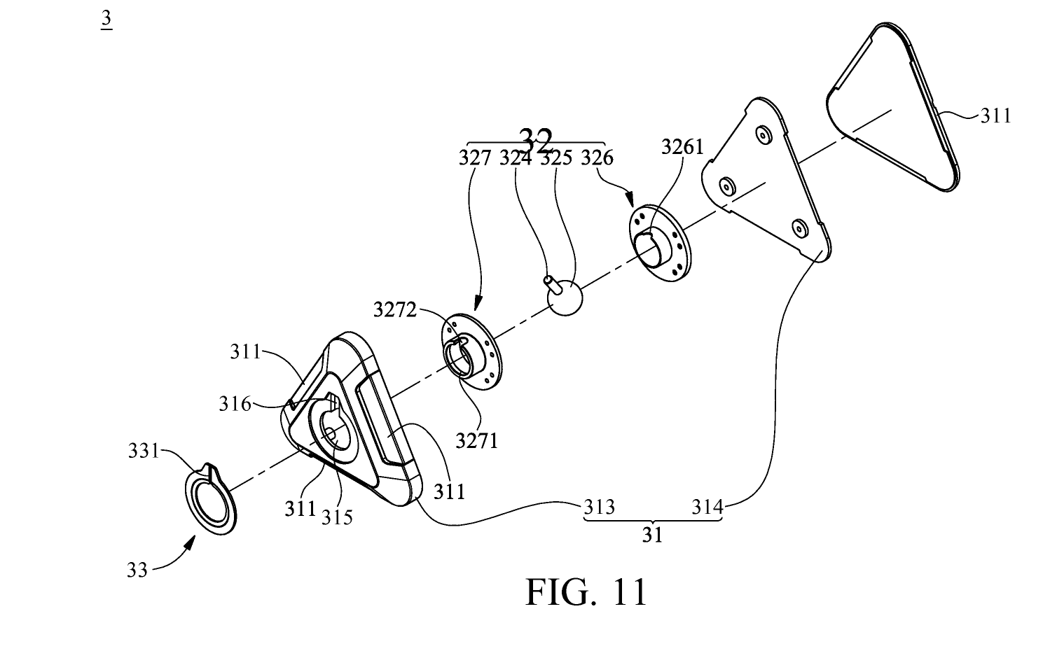

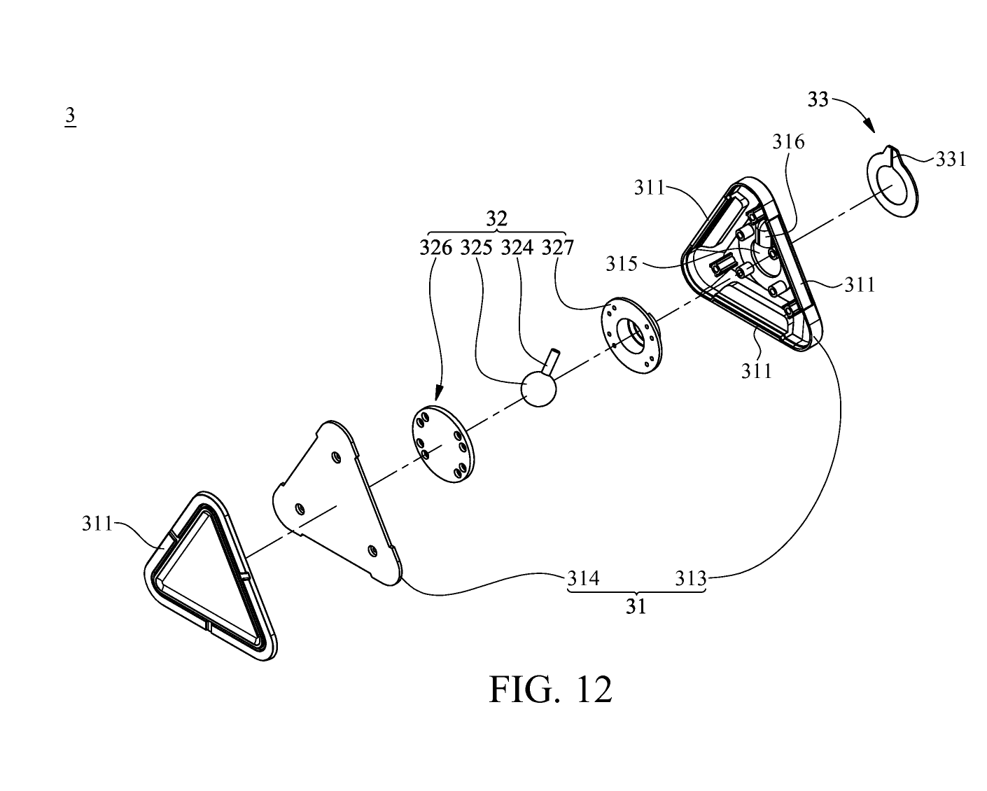

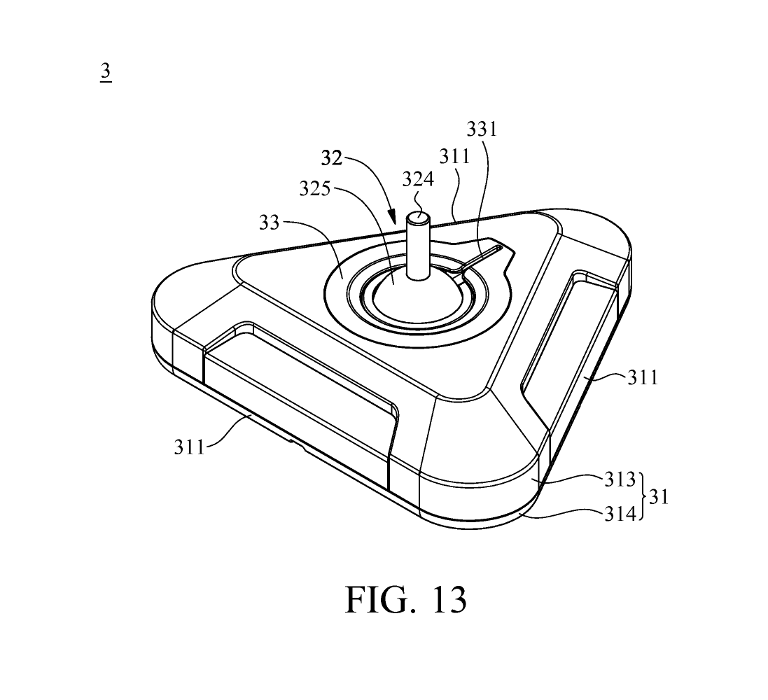

Referring to FIGS. 11 to 13 and FIGS. 16 to 18. The massage device according to the second embodiment may further include a supporting member 3, which is formed of a swivel joint 32 and a base 31. The swivel joint 32 is magnetically attractable, and has an end releasably magnetically attracted to the magnetic attraction member 112 on the first end of the shaft 1 and another end connected to the base 31. The magnetically attractable swivel joint 32 includes an engaging rod 324, which is adapted for fitting in the connection recess 11211 of the shaft 1 and can be releasably magnetically attracted to the magnetic member 1122 in the shaft 1. The swivel joint 32 further includes a connection ball 325, a semicircular ball seat 326, and a ring-shaped cover 327. The engaging rod 324 has an end connected to the connection ball 325; the connection ball 325 is movably received in the semicircular ball seat 326; and the ring-shaped cover 327 is disposed on a top of the semicircular ball seat 326 and has a radially inward protruded top rim 3271 that stops the connection ball 325 from moving out of the semicircular ball seat 326 via the ring-shaped cover 327. In another operable embodiment, the connector 11 is not a magnetic attraction member 112 but a recessed fitting groove (not shown), while the swivel joint 32 is not magnetically attractable but has an annular flange (not shown) formed on an outer surface of the engaging rod 324 for detachably fitting in the recessed fitting groove. In a further operable embodiment, the connector 11 is not a magnetic attraction member 112 but an annular flange (not shown), while the swivel joint 32 is not magnetically attractable but has a recessed fitting groove (not shown) formed on around a free end of the engaging rod 324 for detachably engaging with the annular flange of the connector 11. In a still further operable embodiment, the shaft 1 does not include the magnetic attraction member 112, while the connection ball 325 is not magnetically attractable and the engaging rod 324 is integrally formed with the shaft 1 to form the connector 11 on the shaft 1 for detachably connecting to the swivel joint 32. In this case, the connection ball 325 is removably fitted in between the semicircular ball seat 326 and the ring-shaped cover 327. With the detachable massage member 2 and the shaft 1 being connected to the supporting member 3 in the above-described manners, the massage device of the present invention can provide expanded massage functions.

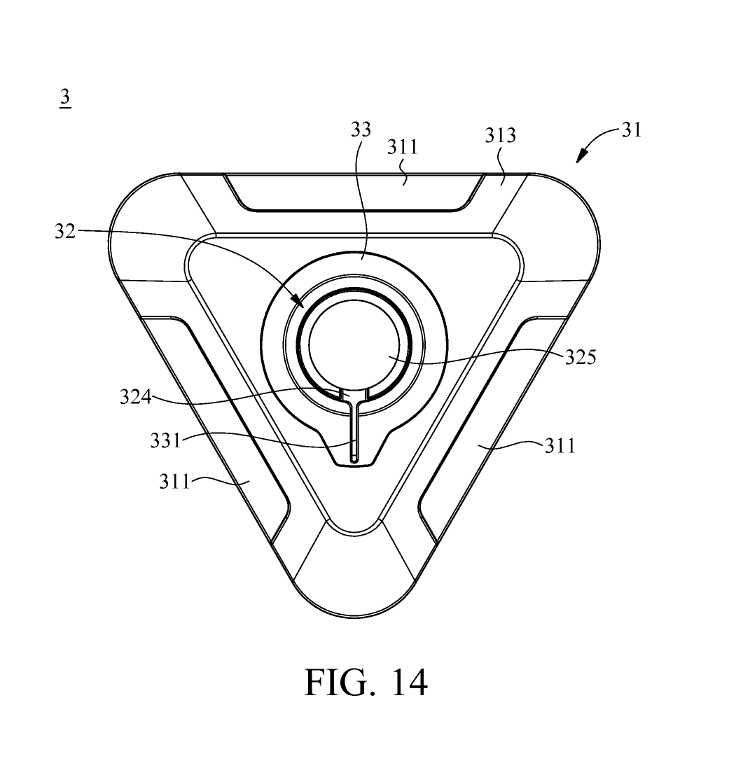

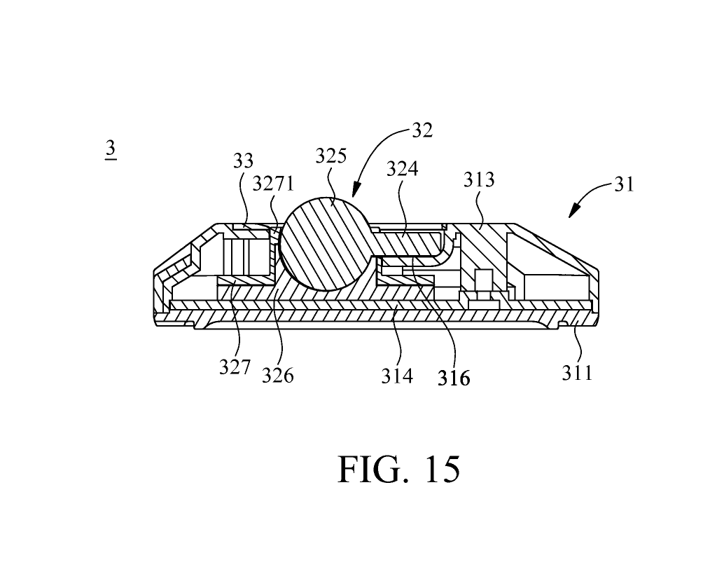

Referring to FIGS. 11 to 15. In the massage device according to the second embodiment, the base 31 of the supporting member 3 includes an upper case 313, a lower case 314, and a receiving space 315 and an extended receiving space 316 formed on the upper case 313. The upper case 313 and the lower case 314 are closed to one another to form a shell of the base 31. The extended receiving space 316 is outward extended from one side of the receiving space 31. The semicircular ball seat 326 and the ring-shaped cover 327 respectively have a notch 3261, 3272 formed on one side thereof corresponding to the extended receiving space 316. The semicircular ball seat 326, the connection ball 325 and the ring-shaped cover 327 are sequentially disposed in the receiving space 315. The notches 3261, 3272 allow the engaging rod 324 to move between the extended receiving space 316 and an outer side of the receiving space 315. When the supporting member 3 is not in use, the engaging rod 324 can be moved into the extended receiving space 316 for convenient storage of the supporting member 3.

As can be seen in FIGS. 11 to 15, in the massage device according to the second embodiment, the supporting member 3 also includes a flexible annular cover plate 33, on which a slit 331 is provided. The flexible annular cover plate 33 is disposed on a top of the upper case 313 to locate outside the receiving space 315 and the extended receiving space 316. The slit 331 allows the engaging rod 324 to move between the extended receiving space 316 and an outer side of the receiving space 315. With these arrangements, when the supporting member 3 is not in use, the engaging rod 324 can be received in the extended receiving space 316 and protected by the flexible annular cover plate 33 against damage.

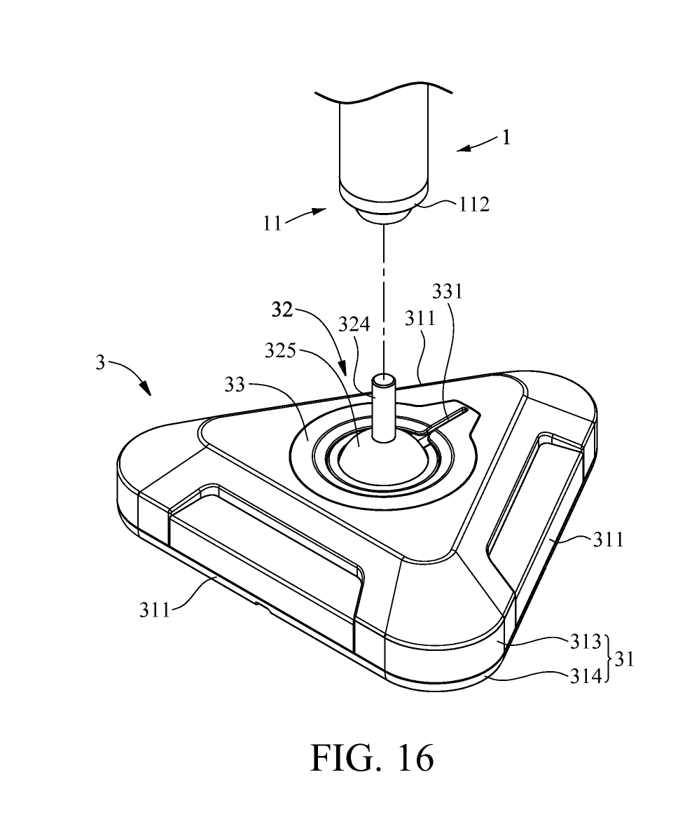

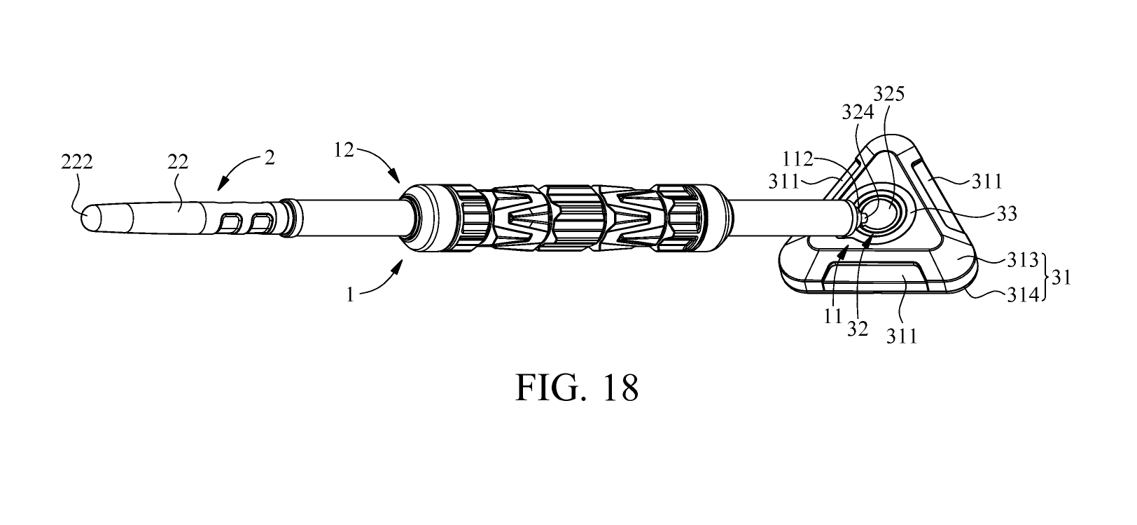

The base 31 for the massage device according to the first and the second embodiment can be polygonal in shape. In FIGS. 9 and 10 as well as FIGS. 16 and 18, the base 31 is illustrated as a flat triangular base. On each of the side surfaces and the bottom surface of the flat triangular base 3, there is provided an anti-slip layer 311, such as a rubber pad. When the user apply a downward force against the detachable massage member 2, the shaft 1, the swivel joint 32 and the base 31, the anti-slip layer 311 on the bottom surface of the base 31 serves to prevent the base 31 from sliding unexpectedly, enabling the massage device of the present invention to have increased stability when it is in use. When any of the anti-slip layers 311 on the side surfaces of the base 31 is in contact with a wall surface, the stability of the massage device in use can be further increased.

As can be seen in FIGS. 9 and 10, in the massage device according to the first embodiment, a massage ball 5 may be further provided and disposed on the base 31. The massage ball 5 enables the massage device of the present invention to provide expanded massage functions.

Meanwhile, as shown in FIGS. 9 and 10, a concave recess 312 can be formed on the base 31 for the massage device in the first embodiment for holding the massage ball 5 therein. Thus, the massage ball 5 can be conveniently disposed on the base 31.

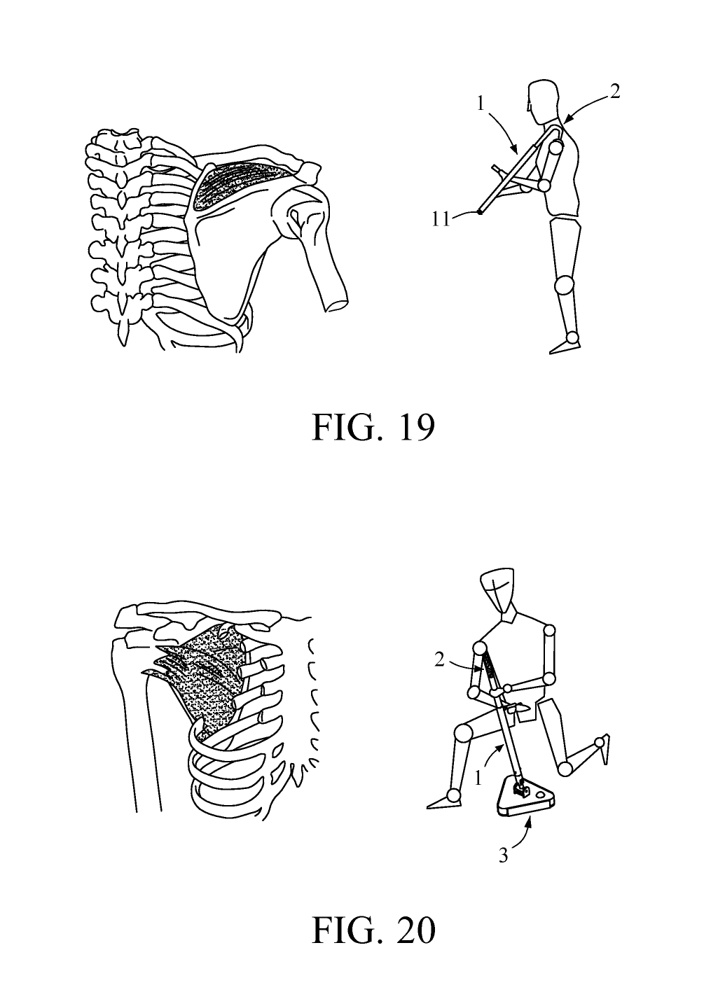

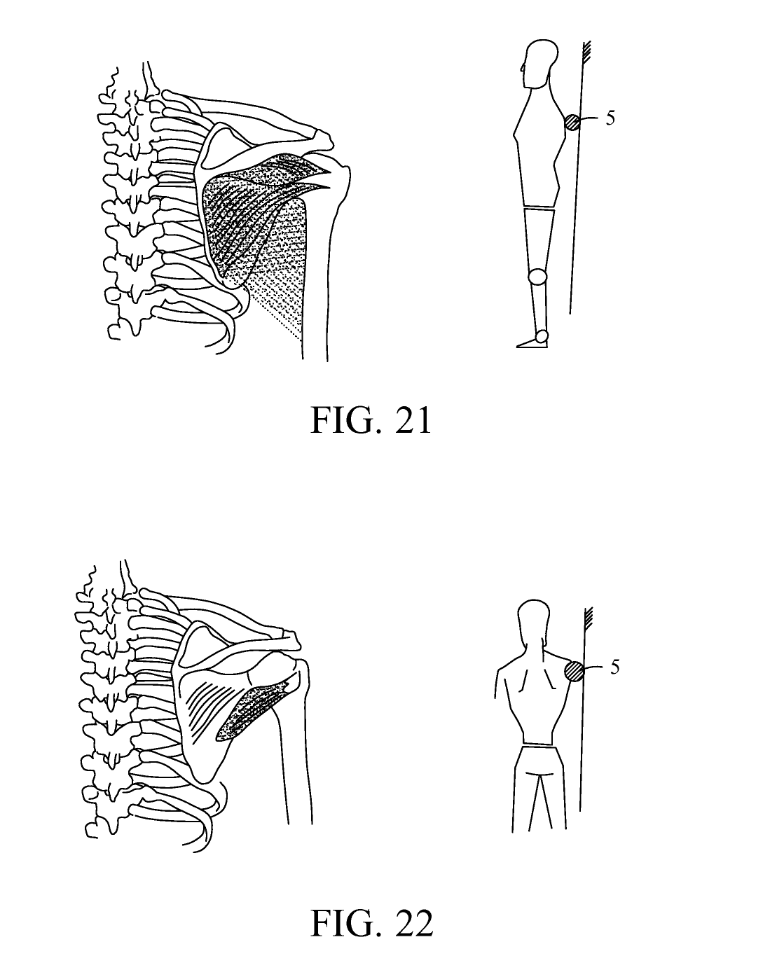

FIGS. 19 to 22 illustrate some examples of using the massage device of the present invention. In FIG. 19, the massage device is used for deep supraspinatus muscle massage. In FIG. 20, the massage device is used for deep subscapular muscle massage. In FIGS. 21 and 22, the massage ball 5 provided along with the massage device of the present invention is used for deep supraspinatus muscle and teres minor muscle massage. Therefore, the massage device of the present invention can be conveniently operated directly by the user to achieve the effect of deep massage of a variety of muscles.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A massage device, comprising:
a shaft having a first end provided with a connector for releasably connecting the shaft to a swivel joint; and
a detachable massage member being detachably connected at a proximal end to a second end of the shaft opposite to the first end.

2. The massage device as claimed in claim 1, wherein the shaft is a lockable telescopic shaft.

3. The massage device as claimed in claim 1, wherein the connector for releasably connecting the shaft to a swivel joint is selected from the group consisting of male fastening means, female fastening means, and a magnetic attraction member.

4. The massage device as claimed in claim 3, wherein the magnetic attraction member forming the connector includes a cap and a magnetic member; the cap being disposed in the first end of the shaft and formed with a connection recess for engaging with the swivel joint; and the magnetic member being disposed in the cap to locate in the vicinity of the connection recess.

5. The massage device as claimed in claim 1, wherein the detachable massage member is selected from the group consisting of a J-shaped rod and a straight rod.

6. The massage device as claimed in claim 1, wherein the detachable massage member is provided at the proximal end with male threads and the shaft is correspondingly provided at the second end with female threads for releasably meshing with the male threads on the detachable massage member; or alternatively, the detachable massage member is provided at the proximal end with female threads and the shaft is correspondingly provided at the second end with male threads for releasably meshing with the female threads on the detachable massage member.

7. The massage device as claimed in claim 1, further comprising a supporting member formed of a swivel joint and a base; and the swivel joint having an end releasably connected to the connector provided at the first end of the shaft and another end connected to the base.

8. The massage device as claimed in claim 3, wherein the magnetic attraction member forms the connector and the massage device further comprises a supporting member; the supporting member being formed of a swivel joint and a base; the swivel joint being magnetically attractable and having an end magnetically attracted to the magnetic attraction member and another end connected to the base.

9. The massage device as claimed in claim 4, further comprising a supporting member formed of a swivel joint and a base; the swivel joint being magnetically attractable and including an engaging rod adapted for fitting in the connection recess of the shaft and magnetically attracted to the magnetic member in the shaft; and the swivel joint having an end connected to the base.

10. The massage device as claimed in claim 9, wherein the swivel joint further includes a connection ball, a semicircular ball seat and a ring-shaped cover; the engaging rod having an end connected to the connection ball; the connection ball being movably received in the semicircular ball seat; and the ring-shaped cover being disposed on a top of the semicircular ball seat and having a radially inward protruded top rim for stopping the connection ball from moving out of the semicircular ball seat via the ring-shaped cover.

11. The massage device as claimed in claim 10, wherein the base has a receiving space and an extended receiving space defined thereon, and the semicircular ball seat and the ring-shaped cover respectively have a notch formed on one side thereof corresponding to the extended receiving space; the semicircular ball seat and the ring-shaped cover being disposed in the receiving space; and the notches allowing the engaging rod to move between the extended receiving space and an outer side of the receiving space.

12. The massage device as claimed in claim 11, wherein the supporting member further includes a flexible annular cover plate having a slit provided thereon; the flexible annular cover plate being disposed on a top of the base to locate outside the receiving space and the extended receiving space; and the slit allowing the engaging rod to move between the extended receiving space and an outer side of the receiving space.

13. The massage device as claimed in claim 7, wherein the base is polygonal in shape to have a plurality of side surfaces and a bottom surface; and an anti-slip layer being provided on each of the side surfaces and the bottom surface.

14. The massage device as claimed in claim 8, wherein the base is polygonal in shape to have a plurality of side surfaces and a bottom surface; and an anti-slip layer being provided on each of the side surfaces and the bottom surface.
